(19) United States
(12) Patent Application Publication
(10) Pub. No.: US 2005/0164691 A1
(43) Pub. Date: Jul. 28, 2005

(54) Method and system of over-the-air activation and modification of a mobile phone

(76) Inventor: Patrick Payne, Vancouver (CA)

Correspondence Address: Robert E Krebs;Thelen Reid & Priest, P O Box 640640, San Jose, CA, 95164-0640, US

(21) Appl. No.: 10/511,456

(22) PCT Filed: Apr. 16, 2003
(86) PCT No.: PCT/CA03/00565

Related U.S. Application Data
(60) Provisional application No. 60/372,731, filed on Apr. 16, 2002.

(51) Int. Cl. H04M 3/00

(52) U.S. Cl. 455/419; 455/418

(57) ABSTRACT

A system and method for over the air activation is provided wherein on activation of a mobile phone, a user is provided with a home page accessible via a computer or the mobile phone. If the home page is accessed via the Internet an image of the mobile phone is displayed and when changes are made to the home page, these changes are observed in such image. Changes to the home page made either via the computer or the mobile phone are observed when viewing the home page with the other access means.

This application claims priority from U.S. Provisional Application Ser. No. 60/372,731 filed on Apr. 16, 2002 by Payne, and the entire disclosure of such provisional application is expressly incorporated herein by reference.

A portion of the disclosure of this patent document contains material which is subject to copyright protection. The copyright owner has no objection to the facsimile reproduction by anyone of the patent document or the patent disclosure as it appears in the public Patent Office file or records but otherwise reserves all copyright rights whatsoever.

1. Technical Field

This invention relates to systems and methods for activating and customizing mobile phones purchased by users, and more particularly systems and methods for users to activate a mobile phone over the air, and customize the mobile phone using the Internet.

2. Background

The wireless industry has two fundamental problems: The first is that initial set-up and configuration of current and next generation mobile phones are both frustrating for the user and costly for the service provider. The second is that the Internet accessed via a mobile phone (the “Mobile Internet”) can be a confusing and unrewarding experience for users, particularly given the limited inputs for navigating the Internet found on a mobile phone. As a result, service providers have not generated significant revenues because adoption of Mobile Internet applications have been slow.

When new users purchase a cellular phone they typically have to go through a cumbersome activation process to activate the mobile phone for use. Such a process usually involves interaction with individuals working for the service provider and frequently results in errors and delays. A reason the process is complicated is the large number of options available to the user (e.g. the number of minutes, voice mail, messaging, internet access, etc.)

Another difficulty with mobile phones is that while their capabilities have increased, such as the ability to display images and music, particularly with respect to 3G capable phones, mobile phones are difficult to program because of the small screen and the lack of inputs (often a 12 button keypad with three or four other buttons), when compared to a computer with a larger screen and a fill keyboard.

Related art includes U.S. Pat. Nos. 6,341,316 and 6,421,717, both to Kloba et al. The Kloba et al. patents disclose a system of enabling web content to be loaded on mobile devices, and for users of mobile devices to operate with such web content on their mobile devices in an interactive manner while in an off-line mode.

### SUMMARY OF THE INVENTION

A method of activating a mobile phone is provided comprising collecting information associated with the mobile phone and a user associated with the mobile phone; based on said information preparing a home page for said user accessible by a computing device or by the mobile phone; and sending a message to said mobile phone providing an address of said home page.

A method of revising a home page by using a computer, the home page displaying an image of an associated mobile phone, is provided comprising: said computer enabled for the selection of media to display on said home page; and when said media is selected, said image changes to preview said selected media on said associated mobile phone.

A system for a user to modify a home page associated with a mobile phone is provided, comprising: a plurality of selectable media at said home page, wherein at least a media is selectable; an image of said mobile phone presentable at said home page; and wherein when said media is selected said image of said mobile phone previews said image on said mobile phone.

A system and method for over the air activation is provided wherein on activation of a mobile phone, a user is provided with a home page accessible via a computer or the mobile phone. If the home page is accessed via the Internet an image of the mobile phone is displayed and when changes are made to the home page, these changes are observed in such image. Changes to the home page made either via the computer or the mobile phone are observed when viewing the home page with the other access means.

### BRIEF DESCRIPTION OF FIGURES

Further objects, features and advantages of the present invention will become more readily apparent to those skilled in the art from the following description of the invention when taken in conjunction with the accompanying drawings, in which:

FIG. 1 is a block diagram showing the high level architecture of a system according to the invention;

FIG. 2 is a block diagram of the architecture of a server according to the invention;

FIG. 3 is a block diagram of a system according to the invention;

FIG. 4 block diagram of the processes whereby a user intializes the mobile phone and accesses the server;

FIG. 5 is a block diagram showing the data associated with a mobile phone;

FIG. 6 is a block diagram showing the settings associated with a mobile phone;

FIG. 7 is a block diagram showing the content associated with a mobile phone;

FIG. 8 is a block diagram showing the high level architecture of a server according to the invention;

FIG. 9 is a block diagram showing mobile phones connecting to the server via the ODBC layer;

FIG. 10 is a block diagram showing mobile phones connecting to the server via the OTA layer;

FIG. 11 is a block diagram showing the system used in an activation process; and

FIG. 12 is a block diagram showing the user of a mobile phone interacting with the system.

### DETAILED DESCRIPTION OF PREFERRED EMBODIMENTS

Terminology

In this document, the following terms will have the following meanings:
“ANI” means Automatic Number Identification;
“API” means Application Program Interface”;
“CID” means Caller Identification;
“CHTML” means Compact Hyper Text Markup Langauge;
“DNS” means Domain Name Server;
“GPRS” means “General Packet Radio Service”;
“GUI” means “Graphical User Interface”;
“home page” means a web page accessible via a user's mobile phone or a computer with access to the Internet. For example, a home page may be written in both HTML and WML.
“HTML” means Hyper Text Markup Language;
“HTTP” means Hyper Text Transfer Protocol;
“ISP” means Internet Service Provider;
“mobile phone” means a portable wireless device capable of voice communications and
interpreting WML, for example a 3G cellular phone;
“user” means the operator of a mobile phone, typically (but not necessarily) the purchaser of the mobile phone;
“MMS” means Multimedia Message Service;
“MMSC” means Multimedia Message Service Center;
“ODBC” means Open Database Connectivity;
“OS” means Operating System;
“OTA” means Over The Air;
“PDA” means Personal Digital Assistant;
“PIM” means Personal Information Manager;
“SMS” means Short Message Service;
“SMSC” means Short Message Service Center;
“SQL” means Structured Query Language;
“SSL” means Secure Socket Layer;
“UAPROF” means User Agent Profiling;
“URL” means Uniform Resource Locator;
“WAP” means Wireless Access Protocol;
“WML” means Wireless Markup Language; and
“XML” means Extensible Markup Language.
   Introduction

The system according to the invention allows users of mobile phones to personalize and customize their mobile phones to their specifications. The system provides users with a personalized dynamically generated website with web pages that can be displayed simultaneously both on the Internet and on their mobile phones. Both the wireless web pages and fixed web pages can be modified and personalized either via a computer connected to the Internet or the mobile phone.

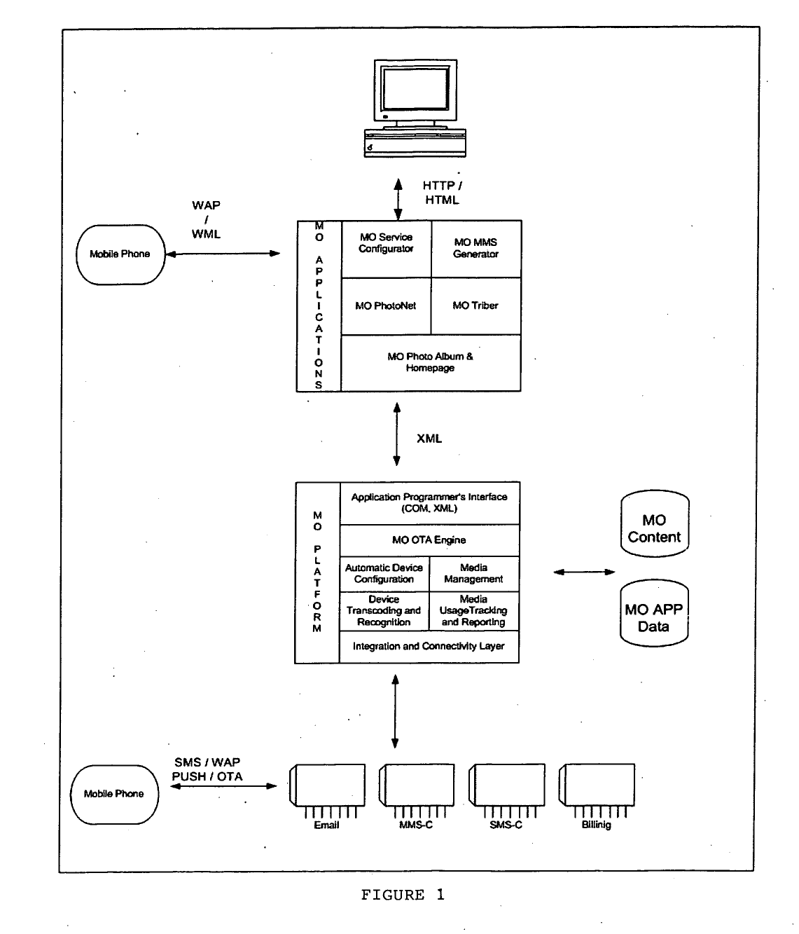

The system uses a combination of servers and applications. The system allows mobile phone service providers to provide services, configure and reconfigure mobile phones over the air, and allows users to self-manage the services and synchronize their mobile phones with their computer. An overview of the system and process are seen in FIGS. 1 through 4.

As seen in FIG. 1, a user with a mobile phone 12 or conventional computer 20 capable of accessing the Internet, can access a suite of applications 25 via WAP or WML using the mobile phone 12 or HTTP/HTML using the computer 20. The applications 25 may include a service configurator 30 (which allows users to select services), a MMS Generator 35, a Photo Sharing service 40, a “Tribe” or community of users 45, and a Photo Album 50.

With further reference to FIG. 1, the applications 25 are controlled via the provider platform 60. Included in the platform 60 are the Application Programmer's Interface 62, which allows programmers to revise applications 25; an OTA Engine 64, used, among other functions, to find a fit for a mobile phone during the activation process among other functions; an Automatic Device Configurator 70, which determines the type of mobile phone, and the type of cellular network, and matches those variables to the user's service profile to configure the mobile phone with the appropriate settings; a Media Management system 68, which displays and organizes the media available to the applications 25; a Device Recognition and Transcoding system 75, which facilitates communication and programming with a variety of types of mobile phones; a Media Usage Tracking and Reporting system 77, which allows the provider to monitor and bill users appropriately; and an Integration and Connectivity Layer 79 to communicate with the servers 90, 92, 94, and 96 described below.

Platform 60 is in communication with Content Database 80 and Application Data Database 85. Platform 60 is also in communication with Email server 90, MMSC server 92, SMSC server 94 and Billing System server 96. Each of these servers 90, 92, 94 and 96 can communicate with mobile phone 12 via SMS, WAP, OTA or push protocols.

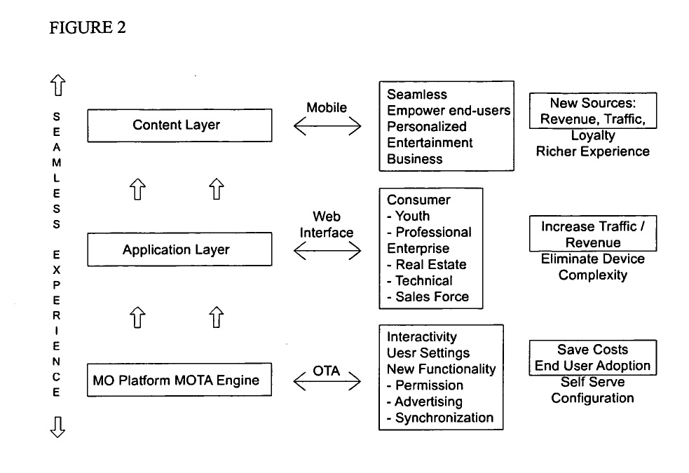

From another perspective, as seen in FIG. 2, the server architecture is designed to provide a seamless experience for a user. The Content Layer 100 provides content and media for the mobile phones 12. The Application Layer 110 is accessed via a Web Interface 115 using a mobile phone 12 or computer 20; and OTA Engine 64 provides OTA functions, including user settings, permissions, and synchronization.

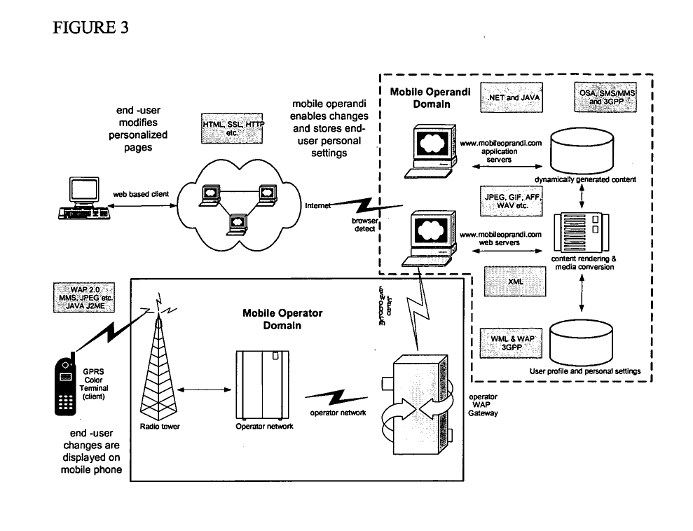

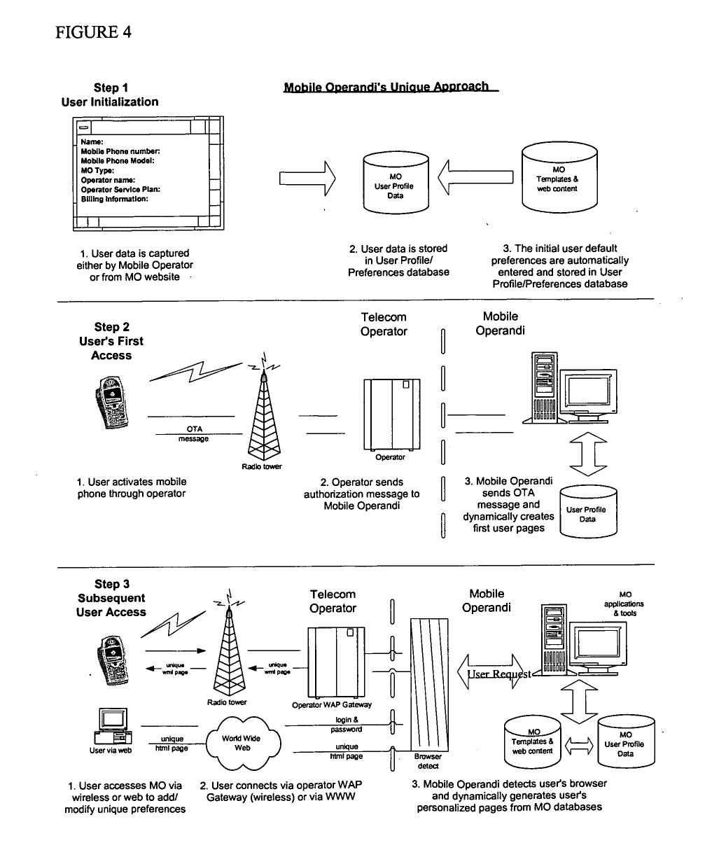

FIG. 3 shows an overview of the system according to the invention providing for synchronization of mobile phone 12 and computer 20 as detailed below. FIG. 4 shows how users access the system, and the mobile phone OTA activation process as detailed below.

The system uses dynamically generated HTML for the Internet component accessible via computer 20 and dynamically generated WML and other wireless components for the wireless environment accessible via mobile phone 12. Traditionally WML for mobile phones has been available only in black and white as not many mobile phones support color and color PDA's typically utilize HTML or Compact HTML (“CHTML”). The system according to the invention preferably supports color WML for mobile phones.

The system includes several dynamically generated templates, in addition to a personal homepage, for the users' website (both wireless and web based) that allows customization and personalization. These templates may be replicated in the wireless environment and dynamically generated by request to the micro browser resident in the mobile phone. This method permits users to modify its personal website and instantly have those changes reflected in its mobile phone or to make changes in the mobile phone and to see the updated changes on its personal web based website.

Over the Air Activation

The system according to the invention allows users to activate their mobile phone without a complicated process. FIG. 4 shows a high level representation of the OTA activation process. In step 1, user data is entered by a salesperson, and sent to the service provider. The information collected includes the mobile phone number, the name of the user, the phone model, billing information and information about the service provider (if a third party is providing the activation service). This information is stored in the User Profile/Preferences Database and default preferences are applied based on either the user data (for example if the user purchased certain features or the particular phone purchased has certain limitations) or as set by the service provider.

In step 2, the user activates the mobile phone through the service provider. The service provider then sends a message to the server, which access the user profile and dynamically generates the user's web page. A message is then sent to the user letting the user know that the phone has been activated and the address of their web page.

In step 3, representing subsequent access to the users web page via the mobile phone or a computer, modifying the web page by the mobile phone or the computer will simultaneously alter the view of the user's web page on the other. For example, if the user accesses his web page via a computer, the server detects the access means and if changes are made to the web page, the modified WML web page is sent to the mobile phone.

Automatic configuration

Mobile phones will be automatically setup and configured if they aer not pre-configured when sold. For example, after a sale of a mobile phone to a user, the mobile phone may need to have its' data, WAP and email settings configured. As seen in FIG. 4, after the mobile phone is configured, a SMS message is sent to the user notifying him or her of the completion of the setup process.

This feature can also be used to configure particular settings needed for new services such as MMS, photo sharing, “tribes”, and other third party content and/or services such as games, premium contact service, etc. For example, photo sharing requires that the mobile phone's ANI/CID option is set to “on”, and MMS requires the MMSC server Uniform Resource Locater (“URL”) as well as other message management settings. If the user, from their home page determines that they would like to be able to send MMS messages, they could subscribe to the service from their home page. The OTA server would then configure the phone as necessary to provide such a service.

The system offers a “one step configuration” initial setup and configuration process for service providers to ease the service subscription process. The system uses a combination of OTA, (dynamic) personalized web space generation, WAP Push and SMS technologies to achieve this via an OTA Server and applications. The sequence of events in this process is described as follows:
1. A sales representative of a service provider is approached by a new user to subscribe to its services.
2. The sales rep fills out a HTML form with basic customer information like name, address, phone number, the mobile phone type, etc. and sends this information to the OTA server.
3. The OTA server stores this information in a user database, creates an appropriate OTA message to setup and configure the mobile phone, creates a personalized web space dynamically in the background, and sends an OTA message. Once the mobile phone is configured, another WAP push message is send to the user saying “Your personal home page is ready. Would you like to see it now? (Yes/No)”.
4. By now, the OTA server has configured the mobile phone for data, email, wap, mms etc.

If the new user accepts the WAP push message, he/she is directed to his/her newly created personalized web space.

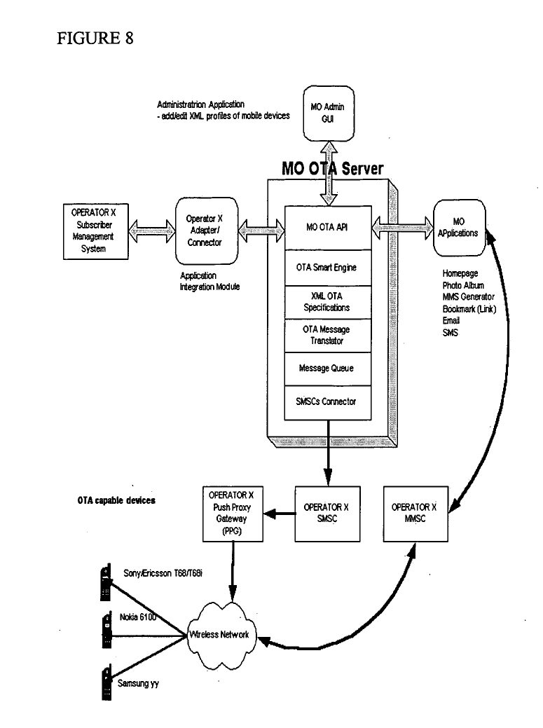

The OTA server used for the OTA process is seen in FIG. 8. It's properties are described below:
OTA Engine: The core of the OTA server is a “smart engine” that finds a “best-fit” solution recommendation for the requested functionality. Mobile phones differ in the level of OTA support and therefore it is not possible to send OTA messages in a uniform manner. For example, some services offered by a service provider may only be activated fully over the air for certain types of mobile phones, and only partly for other types of mobile phones. Therefore, the OTA Engine matches the requested activation message to the mobile phone and selects the best-fit solution.

Every mobile phone has specific attributes and constraints. For example, screen size, color scale, picture formats supported, underlying OS etc. vary from type of phone to type of phone. It is possible to support a handful of mobile phones by recording all of these attributes and constraints for every type of mobile phone and matching these attributes and constraints to the requirements for the requested OTA service. However, as the number of mobile phones to be supported and the services offered grows, the problem of finding a solution grows exponentially.
XML OTA Specifications: This is where the OTA capabilities of all the supported mobile phones are specified and stored in XML format.
OTA Message Translator: This component translates the generic OTA message request into the specific mobile phone format and encodes into a compatible binary format.
Message Queue: All the OTA messages are stored in a highly scalable and reliable message queue for delivery.
SMSCs Connector: These components connect to the operator SMSCs via which the messages in the Message Queue are delivered.
Application Integration Module: This module is custom made for each service provider using the OTA server, so that the service provider's subscriber management system is connected to the OTA server.
Administrator GUI: The XML OTA specifications can be edited, added and deleted using this administration application.
Applications: These are the suite of applications that use the OTA API.

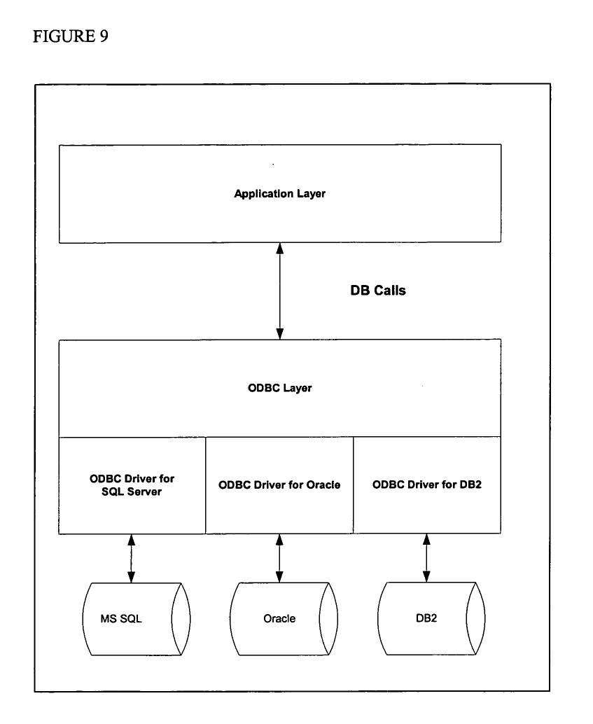

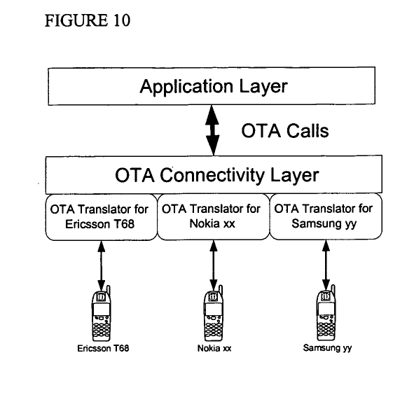

The OTA Engine consists of a generic API that can be used to make OTA messages in the same way regardless of the type of the target mobile phone. The target mobile phone specific OTA messages are created by the respective translators, in a process similar to that of ODBC, where the ODBC layer does not change regardless of the target databases, and there are specific ODBC database drivers for each target database. For reference see FIGS. 9 and 10.

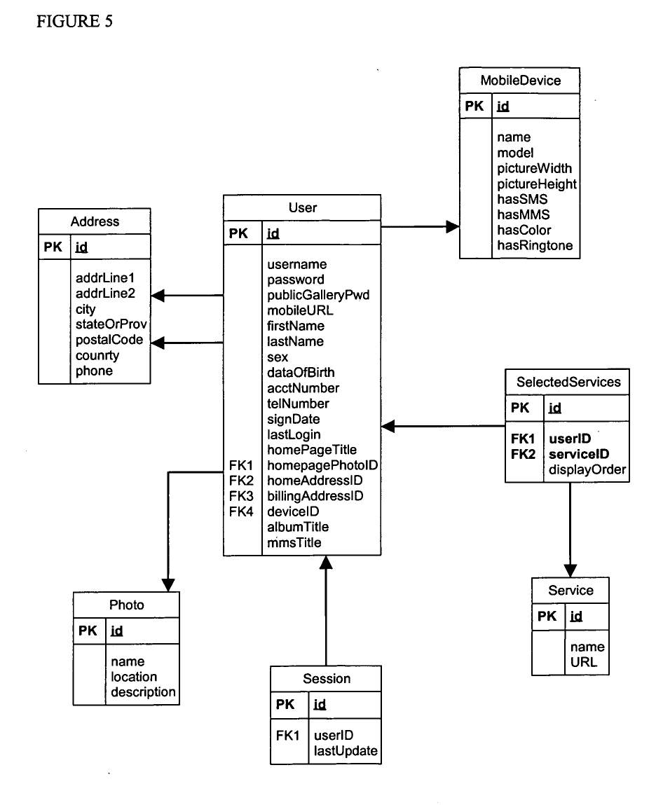

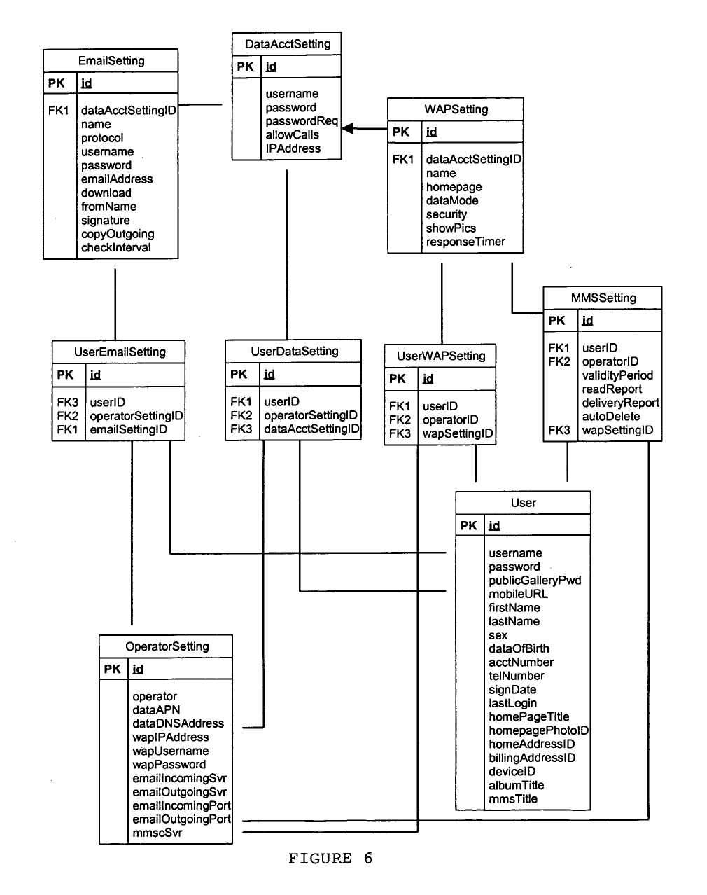

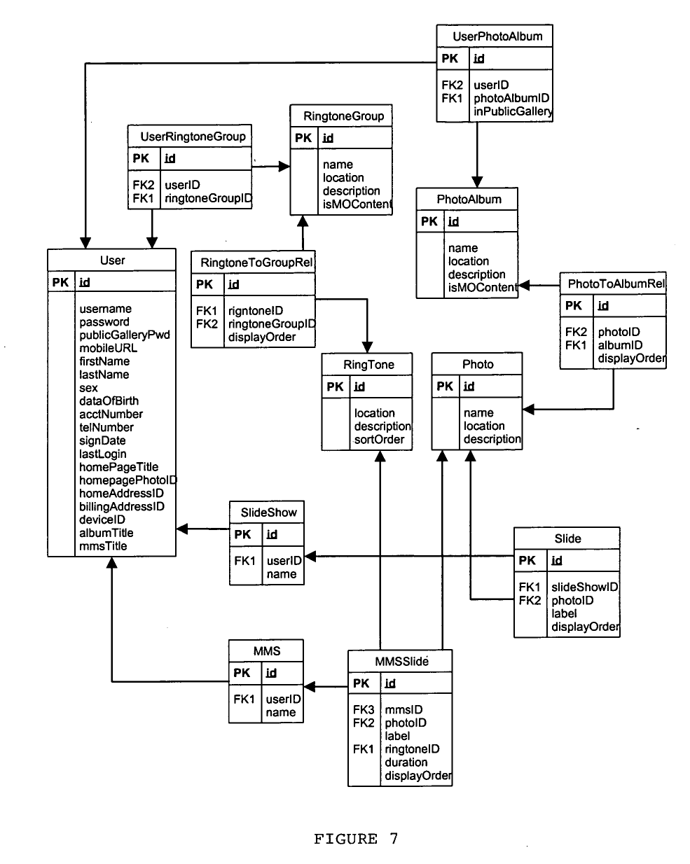

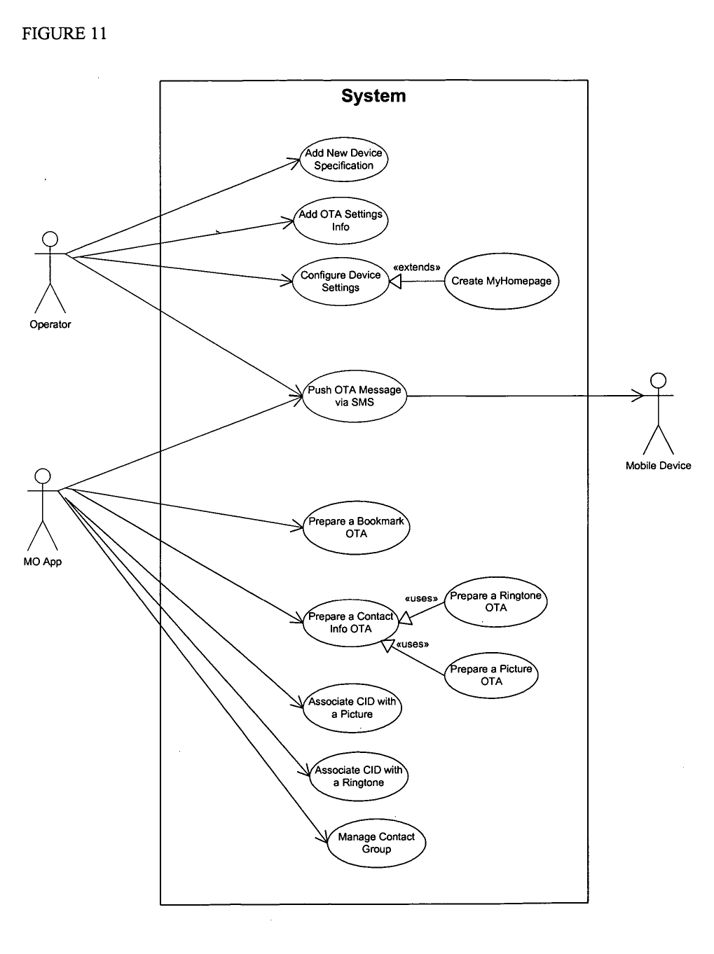

FIG. 11 shows the functions performed by the OTA server. The actors using the OTA server are the operator, e.g. the salesperson at the service provider's outlet; the suite of applications; and the mobile phone carried by the end user. The data specifications described below and the data structures shown in FIGS. 5 through 7 are examples of such that could be used in implementing a system according to the invention, however, as known in the art other data specification and structures could be used.

Functions performed with the OTA server include:
Add New Mobile Phone Specification: The operator adds a new mobile phone specification which includes information such as its display, memory etc. The operator is provided with a form to enter a new mobile phone specification. The operator can update the main mobile phone database. The new mobile phone record shall be available to use by other applications.

The data fields for the mobile phone record and the type of field are:

| Data Field (Column) | Type |
|---|---|
| Display length (pixels) | Number |
| Display height (pixels) | Number |
| Memory (KB) | Number |
| MMS capable | Boolean |
| Java phone | Boolean |
| Java version | String |
| Device constraints | String |

Add OTA Settings Info: The operator adds OTA settings information such as ISP configuration, MMS server url etc. Operators will need to enter the operator-specific settings for items such as ISP, WAP gateway, MMS etc. This provides basic initial setup functionality.

The operator completes a form to enter (or initialize) basic operator-specific settings. The data for these settings are described below. The user stores this data in an OTA server database. All applications generating OTA messages will use this data for the settings and configuration of the appropriate mobile phones.

The Data fields, type and interaction are as described below:

| Data Field (Column) | Type | Interaction |
|---|---|---|
| Data APN | Char( ) | |
| Data DNS | Char( ) | |
| WAP Gateway IP Address | Char( ) | Data entry |
| WAP Username | Char( ) | Data entry |
| WAP Password | Char( ) | Data entry |
| Email Incoming Server | | |
| Email Outgoing Server | | |
| Email Incoming Port | | |
| Email Outgoing Port | Char( ) | |

The MMS Server settings include:

| Data Field (Column) | Type | Interaction |
|---|---|---|
| MMSC Server URL | Char( ) | |

Configure Device Settings: The operator configures settings of a user's mobile phone. Users need to be able to configure and set-up their mobile phone and connect to the mobile Internet via the operator's network. This includes setting certain parameters on the device such as WAP gateway settings, IP address, data communication accounts and preferences, connection type, user idenitification, password, and DNS settings. This initial set-up and configuration of current and next generation mobile phones is a task that is both frustrating for the user and costly for the operator. An over the air configuration (OTA) technology will configure the mobile phone settings in a single keystroke.

Before this can be done, the operator must have configured settings for the user using the configuration settings parameters and sending a request to the OTA server. The operator is informed whether the request has been completed successfully or not. The OTA server prepares an OTA message with the configuration parameters and pushes it to the user's mobile phone. The personalized homepage for the user is dynamically generated in the background and the user is notified with a SMS when the configuration is complete. The message should say “Your personal home page is ready. Would you like to see it now? (Yes/No)”. If the user answers “Yes”, he/she shall be taken to his/her personal home page.

When complete, all session status and information will have been stored to the system and the mobile phone of the user will have been configured.
Create My Homepage: The OTA server creates a personalized homepage for the user. Once the operator sends a request to configure a mobile phone, a generic homepage with some personalization is created in the background. This gives the user instant access to various applications and resources soon after the mobile phone is configured. Thus, in a short period of time, the mobile phone of the user is set-up with, for example, internet and email settings, and the user is ready to be taken to its homepage.

The system starts this process by requesting configuration settings for a new user. The system dynamically generates (in the background) a home page for the new user. The home page title is preferably personalized with the name of the user. The home page should have a list of pictures that the user can select for the mobile phone, defaulted to a generic picture. The home page should have a list of applications available for the user to select for the mobile phone, with some already selected by default. The home page will have a link to the service provider homepage, including access to web pages with applications and content.

The fields used by the server to complete this process include:

| Data Field (Column) | Type | Interaction |
|---|---|---|
| Homepage Title | Char( ) | Use the user's name as default |
| Homepage Picture | Char( ) | Use a default from a generic list |
| Applications | Array of | Default a number of applications |
| | Char( ) | from a from a generic list |
| Mobile Phone Image | Char( ) | Use a default from a list of |
| | | supported devices |

Push OTA Message: Pushes an OTA message via SMS channel to a mobile phone. The OTA server is integrated with an operator SMS-C to send OTA prepared OTA messages via a SMS control channel. The OTA server is integrated with an operator's SMS-C. The user shall have a way of sending a prepared OTA message to a mobile phone using the integrated SMS-C.
Prepare Bookmark OTA: Prepares a bookmark OTA message for a mobile phone.
Prepare Contact Information OTA: Prepares a PIM information OTA message, including picture and ringtone.
Prepare a Ringtone OTA: Prepares an OTA message to send a ringtone to a mobile phone.
Prepare a Picture OTA: Prepares an OTA message to send a picture to a mobile phone.
Associate CID with a Picture: Prepares an OTA message to associate a picture to a CID.
Associate CID with a Ringtone: Prepares an OTA message to associate a ringtone to a CID.
Manage Contact Group: Prepares an OTA message to manage contacts in a group or list.

FIGS. 5 through 7 indicate representative data structures that can be used to implement the OTA server functions and the services described below. As known in the art, other data structures may be equally applicable.

Real-time Web to Wireless Device Synchronization

The OTA server and applications allows for the desktop to mobile phone synchronization via the Internet using standard HTTP protocol as shown in FIG. 3. This does not require any additional software on the user's computer, and does not require any physical connection between the mobile phone and the computer.

Users can update and synchronise personal information like contacts, and groups can be synchronized using HTTP. Any changes made to the personalized applications and content are immediately reflected in the mobile phone. If the personal web page is accessed, the user may opt to view an image of the mobile phone in the web page. When changes are made to the home page, for example by selecting a new image as a background for the mobile phone, the change will be reflected immediately on the mobile phone, and on the image of the mobile phone that can be viewed at the web page. This allows users to experiment even if the mobile phone is not present.

An important aspect of the system is that it is permission based. For example, a typical photo sharing scenario takes place as follows:
1. Mary sends her friend Jane a photo sharing contact.
2. Jane is alerted of the incoming contact from Mary and asked to accept or decline.
3. If accepted, Jane's contact information in the mobile phone and in the web space is updated by the OTA and application server.
   This allows users to prevent unwanted or unnecessary information to be downloaded in the mobile phone.
   Services

The services described below can be accessed via the mobile phone or a computer.

Once a user is set-up and configured, the user's personalized web space will include services that are available but not yet subscribed. The operator will be able to control which services appear in this space. The user can then sign up for these services by selecting them at the user's web page. An example of such user initiated service request is as follows:
1. A user selects an available but not yet subscribed service that is listed in the user's home page.
2. The service provider may require the user's mobile phone configuration and or web space configuration. This is handled by the OTA server and the applications.
3. The OTA server will generate the appropriate OTA message for the set-up and configuration of the requested service. For example, if it is MMS service, the mobile phone's WAP push settings must be turned on and MMS URL setting in the phone must be populated with the operator's MMS-C address.

Users can manage their multi media applications on the mobile phone such as photos, ringtones, slideshows etc. using the computer. However, the mobile phone can also be used to create and save new wireless media such as screensavers, wallpapers, fonts, etc. This feature allows the web desktop and the mobile phone to synchronize the media, that is, downloads and uploads are possible via both.

Applications such as “tribes” (i.e a community of users who receive messages, etc.) and photo sharing, require both photos and ringtones to be delivered to multiple mobile phones. This needs to be permission based, that is, the recipient can choose to accept or reject any request to save new media into its mobile phone. These media are delivered via a MMS server and email server. A SMS server is used to send SMS messages for user authentication and acknowledgement.

Other features include media transaction tracking and reporting, which allows service providers to track transactions and report on all activity for each media file, user, account or customer. This data can be used for detailed billing information by an operator's billing system, and device recognition and transcoding, which is used for intelligent device recognition (using the UAPROF standard), and delivery of multi media messages using optimized encodings for a mobile phone. That is, transformations and conversions are carried out based on the mobile phone type, network type (MMS, SMS, WAP etc) and network (GSM, CDMA, GPRS etc).

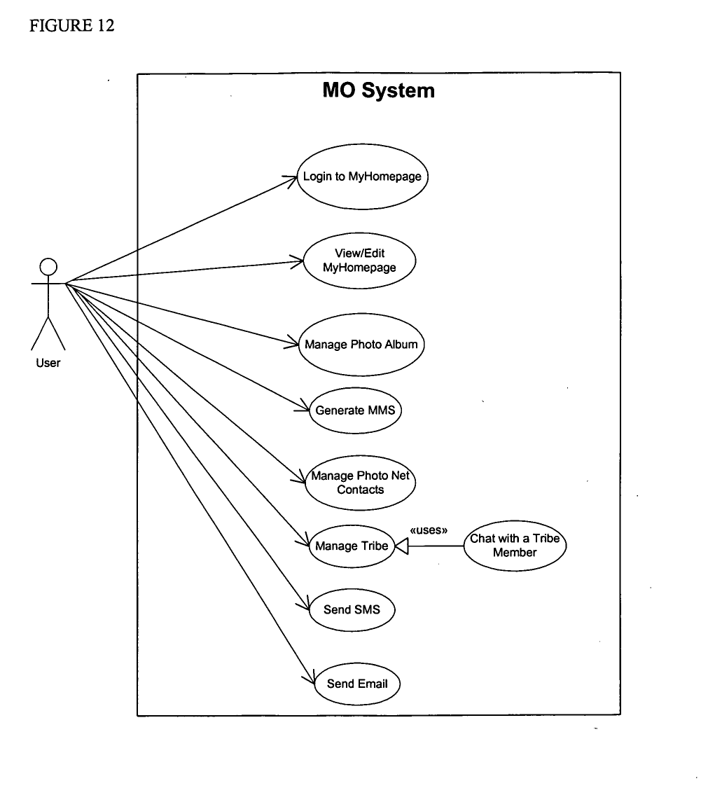

Options available for a user, as seen in FIG. 12 include:
Login to My Home page: The user presents its credentials to access its home page. This occurs when the user accesses the personalized home page via a landline fixed Internet terminal. The system needs to uniquely identify the user before presenting its personal home page. When the user's home page is accessed via the user's mobile phone, this process is not necessary as the unique user identity can be implicitly determined (using the CID).

The user begins by going to the appropriate web site where it is presented with a login page. The user enters its credentials. If the user forgets the password, a reminder system may be used. If the credentials do not exist, the user is denied access. If the login is successful, the user is presented with his/her home page.

Data Specification

| | |
|---|---|
| MO_1_x | Login Data |

The user shall be asked to supply his/her credentials using the data as
specified hereby.

| Data Field (Column) | Type | Interaction |
|---|---|---|
| Tel. Number | Char( ), in “(000) 000-0000”. | Data entry |
| Password | Char( ) | Data entry |

View/Edit My Home page: The user can views/edits its personalized home page that was created dynamically during the initial configuration and setup of the mobile phone. The user enters this process after successfully logging in or accessing the home page via the mobile phone. From the home page, the user can use the Applications and Content. There should be links from the user's home page to the service provider's web site. In a preferred embodiment the user can enter the title for the home page as freeform text.

The user can select the image of a mobile phone from a list of supported mobile phones and can select a picture from a list of images. This picture appears in the homepage and is used to preview images on the mobile phone. The user can also select applications to access from the mobile phone from a list of available applications.

The user can also view its WML homepage. From the WML homepage, the user can invoke Applications, access Content and access the service provider web site.
Manage Photo Album: The user adds photos, edits labels, and manages the photo album. The user can view or edit the homepage that was created dynamically during the initial configuration and set-up of the mobile phone. The user can organize photos in folders (or albums) that are two levels deep; can add, remove and rename photo albums; can display photos (image); and can select photos and rearrange the sequence of photos in an album (e.g. by dragging and dropping).
The user can also select a photo (in JPEG and GIF format) from a local disk and add to a selected album, and can remove a photo from an album, label a photo in an album, and mark an album to be public so that it can be viewed by other users.
The user will be able to preview a selected photo on the mobile phone image and can create, view, and organize slideshows of photos. Slideshows are a sequence of pictures that can be selected from different albums.
Generate MMS: The user picks and chooses items to generate a MMS message. The user can create MMS messages using photos, a ringtone, and a text message for each photo. MMS messages are generated using SMIL markup language. The user will be able to preview animated MMS messages in a mobile phone image, similar to photo preview in photo album and can save MMS messages in binary encoded format ready to be sent.
Manage Photo Net Contacts: The user adds, deletes, and updates photo sharing contacts.
Manage Community: The user can add, delete, and update community (“Tribe”) members. Alternatively a single person may have the ability to do this for a particular tribe (e.g., and administrator).
Chat with a Community Member: The user chats with another community member using the mobile phone (by placing a phone call) or the computer.
Send SMS: The user sends a SMS message. The message can be sent to an individual or a plurality of individuals (e.g. all community members).
Send Email: The user sends an email message.

While the principles of the invention have now been made clear in the illustrated embodiments, it will be immediately obvious to those skilled in the art that many modifications may be made of structure, arrangements, and algorithms used in the practice of the invention, and otherwise, which are particularly adapted for specific environments and operational requirements, without departing from those principles. The claims are therefore intended to cover and embrace such modifications within the limits only of the true spirit and scope of the invention.

1. A method of activating a mobile phone comprising:
collecting information associated with the mobile phone and a user associated with the mobile phone;
based on said information preparing a home page for said user accessible by a computing device or by the mobile phone;
sending a message to said mobile phone providing an address of said home page.

2. The method of claim 1 wherein said information includes default information selected by a service provider associated with the mobile phone.

3. The method of claim 2 further comprising:
configuring said phone based on said information.

4. A method of revising a home page by using a computer, the home page displaying an image of an associated mobile phone, comprising:
said computer enabled for the selection of media to display on said home page;
when said media is selected, said image changes to preview said selected media on said associated mobile phone.

5. A system for a user to modify a home page associated with a mobile phone, comprising:
a plurality of selectable media at said home page;
an image of said mobile phone presentable at said home page;
wherein when said media is selected said image of said mobile phone previews said image on said mobile phone.

6. The system of claim 5 wherein said home page is viewable via a computer or by a mobile phone.
